(19) United States
(12) Patent Application Publication
(10) Pub. No.: US 2005/0246363 A1
(43) Pub. Date: Nov. 3, 2005

(54) System for self-correcting updates to distributed tables

(76) Inventor: Gregory F. Paussa, Cary, NC (US)

Correspondence Address: NEEDLE & ROSENBERG, P.C., SUITE 1000, 999 PEACHTREE STREET, ATLANTA, GA, 30309-3915, US

(21) Appl. No.: 11/020,426

(22) Filed: Dec. 22, 2004

Related U.S. Application Data
(60) Provisional application No. 60/567,769, filed on May 3, 2004.

(51) Int. Cl. G06F 17/00

(52) U.S. Cl. 707/101

(57) ABSTRACT

An efficient self-correcting system for updating a data table used in a distributed networking environment is described. The system attempts to change an entry in the distributed data table in response to processing the update request. A first indicator is set to reflect whether the entry was successfully changed. The system periodically compares a maximum table capacity level with a current table capacity level. Periodically, a second indicator is set to reflect the current table capacity level. The system periodically attempts to change the entry so long as the first indicator reflects a previously unsuccessful change and the second indicator reflects less than the maximum table capacity level. The unique system may be implemented in a computing device that has a main and distributed data table, a processor, and an apparatus with algorithms that is coupled to the processor. The algorithms self correct updating errors for the distributed data table.

### CROSS REFERENCE TO RELATED APPLICATIONS

This application claims priority to U.S. Application No. 60/567,769, filed May 3, 2004. The aforementioned application(s) are hereby incorporated herein by reference in their entirety.

### FIELD OF THE INVENTION

The present invention generally relates to a system for self-correcting updating errors associated with a table. More specifically, the invention relates to a system for updating a data table used in a distributed networking environment in a manner that periodically corrects errors generated during the update process.

### DESCRIPTION OF THE RELATED ART

With the growing number of technological advancements, computer systems are becoming increasingly more complex. They may both store and process information in a host of locations. Some systems even use various components to independently process different kinds of information. When the workload of a system is distributed among its collaborative elements, the associated data may be distributed as well. Some examples include master/slave, client/server, peer-to-peer, or other type of arrangement.

Distributing data may create several challenges. A distributed work environment may be challenging because of errors associated with using a distributed table. For example, a processor may attempt to add an entry to the distributed table during a table update process. The processor may make this attempt by believing that there is enough room in a distributed table to add an additional entry because the table is not full. However, the add attempt may fail because the location within the distributed table where the processor is adding the entry is actually full. Because the processor does not realize this, an internal constraint error occurs.

The structure of a distributed table contributes to the creation of internal constraints. FIGS. 1A and 1B are block diagrams illustrating the manner that entries are added to a distributed data table 100. A distributed table may consist of a series of finite-sized hash lists or arrays, which may individually reach capacity before the entire distributed table is considered full. The distributed data table 100 may include a fixed number of storage areas with a finite number of entries per storage area. One portion of the table may include 128 storage areas, or hash groups. Each individual storage area, or hash group array, may include eight entries.

As shown in FIG. 1B, one hash group 0 may include one entry, while another hash group 2 may include eight entries after some time t. Therefore, hash group 2 with eight entries is considered full, though unknown to a controlling processor. Because the latter hash group is the only full group, the distributed table 100 as a whole is not considered full. If at some subsequent time t+2 hash group 2 is still full and it is selected for storage of an entry, the operation will fail and cause an update error. The failure will occur even though the distributed table 100 is not full, which demonstrates the internal constraint.

Using a distributed data table may also create sequencing challenges that complicate the synchronization process. Typically, the synchronization process only modifies or deletes an entry after it has been added. Because internal constraints may prevent a successful add from occurring, the synchronization process may be hindered. An additional complication arises once the distributed table has gotten out of synchronization for a particular entry. That is, typical add, modify, and delete table actions performed for that entry must be amended by the synchronization process to ensure the distributed table is properly maintained. In other words, the synchronization process must make sure that it does not attempt to modify an entry unless it is certain that it was successfully added, nor attempt to delete an entry that does not exist in the distributed table. Moreover, additional problems may result from attempting to modify or delete non-existent entries, such as causing the device to malfunction. Similarly, failing to automatically retry entry add failures may prevent a device from performing as expected.

Thus, there is a general need in the art for a more effective approach to updating distributed data tables that does not sacrifice the efficiency in utilizing a distributed work environment. There is a further need for a table update approach that may correct errors resulting from the add, modify, and delete actions occurring out of sequence. Moreover, there is a need for an update approach that does not unduly burden computer resources in solving the above-identified problems.

### SUMMARY OF THE INVENTION

The present invention meets the needs described above in a system for updating a data table used in a distributed networking environment in a manner that periodically corrects errors generated during the update process. This unique system may operate at peak operating efficiency by self-correcting errors that may occur while updating a distributed data table. This error correction substantially reduces the number of interrupts to the update process, which increases the operating efficiency.

Generally described, the system self corrects updating errors to a distributed data table. To do this, the system adds an entry to the distributed data table after receiving an update request. The system sets a first indicator to reflect whether adding the entry was successful. The system also periodically compares a current table capacity level with a maximum table capacity level. Finally, the system periodically attempts to add the entry so long as the first indicator reflects a previously unsuccessful add and the current table capacity level is less than the maximum table capacity level.

More specifically, the system self-corrects updating errors to a distributed table by processing a first update request. The system also attempts to change at least one entry in the distributed data table in response to processing the update request. A first indicator is set to reflect whether the entry was successfully changed. The system periodically compares a maximum table capacity level with a current table capacity level. Periodically, a second indicator is set to reflect the current table capacity level. Finally, the system periodically attempts to change the entry so long as the first indicator reflects a previously unsuccessful change and the second indicator reflects less than the maximum table capacity level.

The inventive system may be implemented in a computing device for self-correcting updating errors. This computing device has a main data table with numerous entries and a distributed data table with numerous entries. The entries in the distributed data table are representatives of entries in the main data table. A processor connects to both the distributed data table and the main data table. This processor periodically produces update requests so the entries in the distributed data table reflect changes in the main data table. The computing device also includes an apparatus for storing algorithms. This apparatus connects to the processor so that these algorithms may self-correct updating errors for the distributed data table.

### DESCRIPTION OF THE FIGURES

The invention may be understood by reference to the following descriptions taken in conjunction with the accompanying drawings, in which like reference numerals identify like element.

FIGS. 1A and 1B are block diagrams illustrating the manner that entries are added to a distributed data table.

FIG. 2 is an environmental drawing depicting a device for implementing the invention.

FIG. 3 demonstrates the components within the computing device of FIG. 2 that facilitate the self-correction of updating errors.

FIG. 4 is a flow chart that demonstrates a table-update process used in self-correcting updating errors.

FIG. 5 is a flow chart of the table synchronization subroutine of FIG. 4.

FIG. 6 is a flow diagram for the recurring task subroutine of FIG. 4.

FIG. 7 is a flow diagram indicating an alternative embodiment for the recurring task subroutine of FIG. 6.

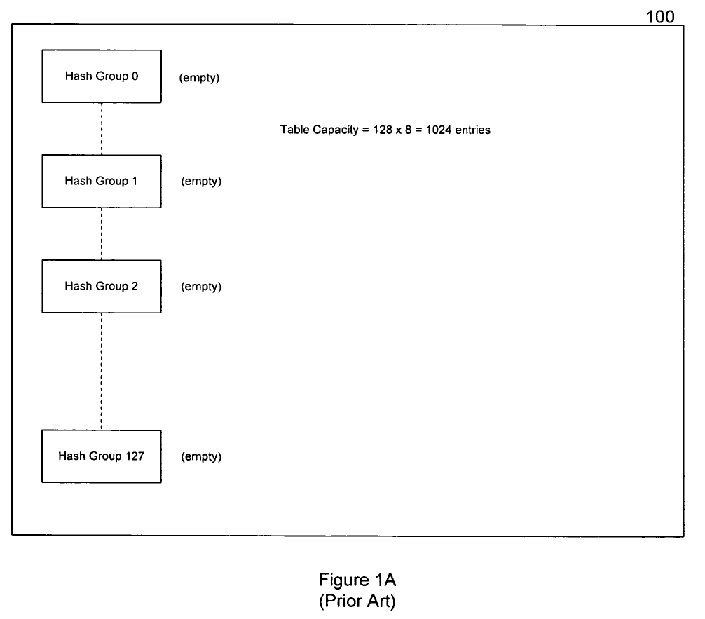

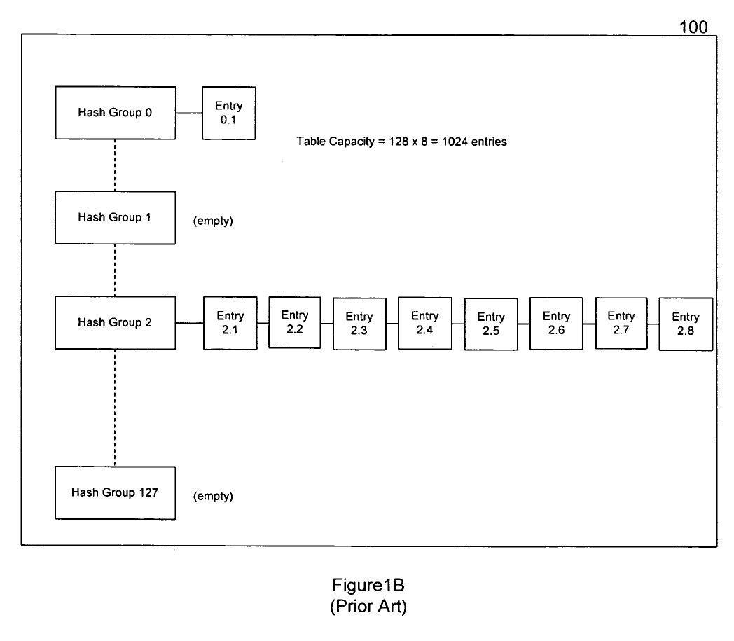

While the invention is susceptible to various modifications and alternative forms, specific embodiments have been shown by way of example in the drawings and subsequently are described in detail. It should be understood, however, that the description herein of specific embodiments is not intended to limit the invention to the particular forms disclosed. In contrast, the intention is to cover all modifications, equivalents, and alternatives falling within the spirit and scope of the invention as defined by the appended claims.

### DETAILED DESCRIPTION OF THE INVENTION

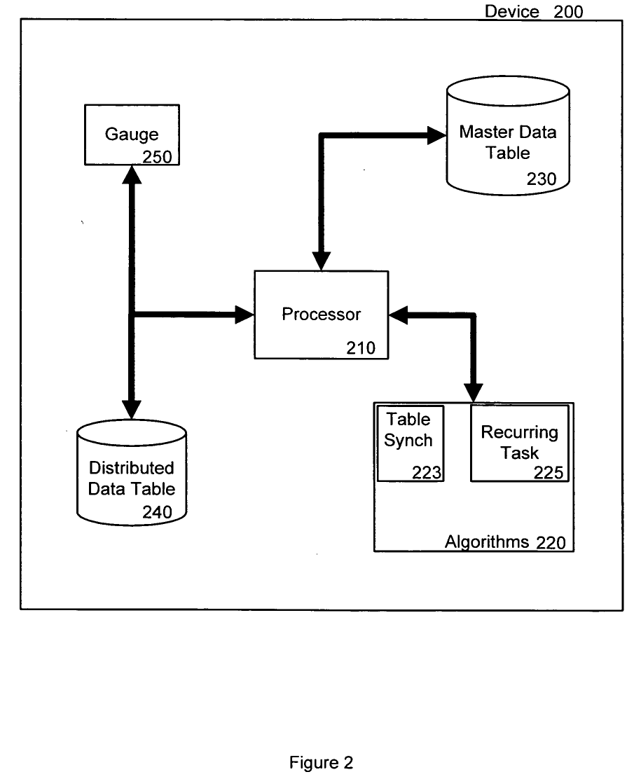

FIG. 2 is an environmental drawing depicting a device 200 for implementing the invention. Specifically, the invention may be implemented in a single computing device 200, which may include various types of devices such as memory storage devices, control devices, and processing devices that may be implemented in either software or hardware. For example, the computing device 200 may include a processor 210, collection of algorithms 220, master data table 230, distributed data table 240, and a gauge 250. With this configuration, original data entries are stored in the master data table 230 while duplicate entries are stored in the distributed data table 240. The duplicates are actually representatives of equivalent entries in the master data table, though these duplicate entries do not have to be identical entries.

To ensure that the entries in the distributed data table 240 reflect the most recent entry in the master table 230, the device 200 periodically updates the data entries in the distributed data table 240 using processor 210. Algorithms 220 and gauge 250 facilitate that update process by self-correcting updating errors. The algorithms 220 may include a table synchronization algorithm 223 and a recurring task algorithm 225. These will be described in greater detail with reference to subsequent figures.

Entries in the distributed data table 240 may contain various kinds of information. Some examples include a value, which may be routing information or address information. In addition, each entry may contain an indicator that identifies whether the last operation was successful (e.g., add indicator) and a failed counter. The failed counter may indicate the number of times the entry was not successfully added.

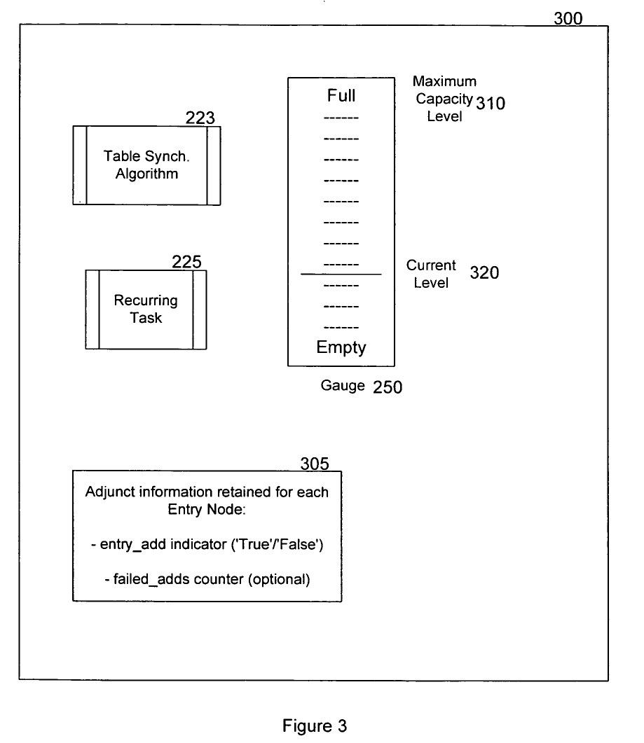

FIG. 3 demonstrates the components within the computing device 200 that facilitate the self-correction for updating errors. They include the table synchronization process algorithm 223, recurring task algorithm 225, gauge 250, and historical information 305. These components may be formed using strictly hardware, software, or some combination. One skilled in the art will appreciate that numerous variations for the computer device 200 may result by selecting hardware, such as field programmable arrays and application specific integrated circuits. Alternatively, the components may be either embedded or general purpose software. In another alternative embodiment, the components may be firmware, such as application specific standard product with device driver software control, or a network processor using a custom control program.

The historical information 305 includes an indicator that depicts whether the current update was successful using a TRUE or FALSE value. This information may also include a failed counter, which tallies the number of times that the current entry was not successfully updated. Therefore, the historical information 305 is stored for each entry within a given table. Though the failed counter and indicator may be stored within a given entry as described above, they may also be stored in a separate location, such as a separate control array used for table maintenance. In an alternative embodiment, the failed counter may not be used at all.

The gauge 250 indicates whether the distributed table 200 includes empty entries. That is, when the distributed table 240 is completely full and has no more empty entries, the gauge 250 registers a maximum capacity level 310. As the device 200 performs various operations, the number of entries within the table varies. The current capacity level 320 indicates the number of entries that the distributed table 240 includes at any given moment. Once the current capacity level 320 is equal to the maximum capacity level 310, the table is considered full.

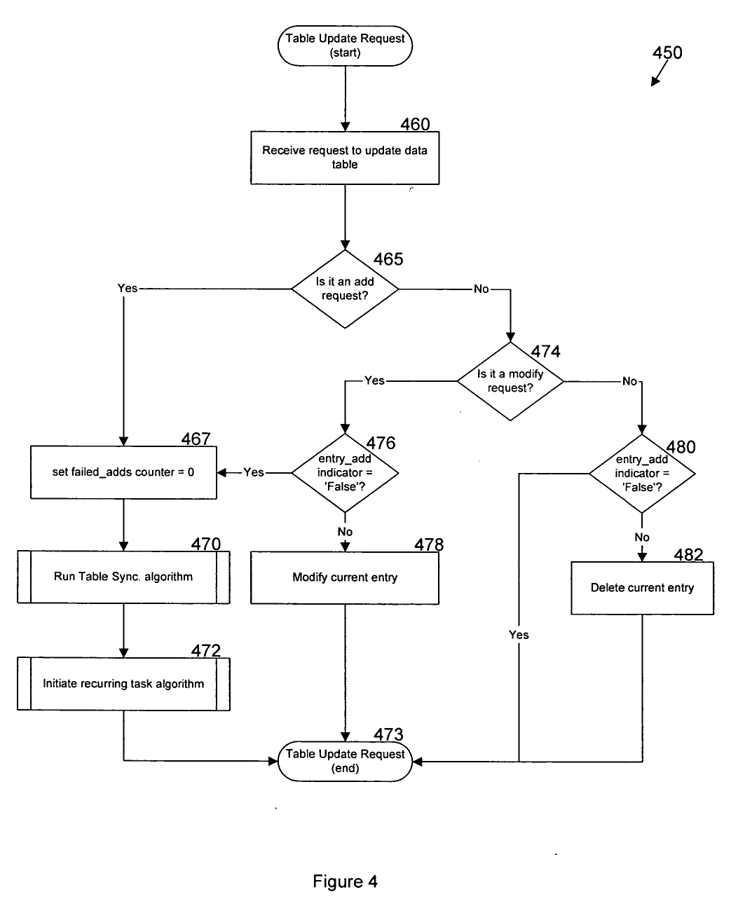

FIG. 4 is a flow chart that demonstrates the table-update process 450 used in self-correcting updating errors for the device 200. In step 460, the update process 450 receives a request to update the distributed data table 140. Generally, this may be initiated by a system event, such as a learned or changed network address or a new or modified route, which signals the table update process 450 with an add, modify, or delete request. In step 465, this process determines if the received request was an add request. That is, the table update process 450 determines whether a new entry should be added to the distributed table 240. In making this decision, the table update process 450 may utilize a separately running protocol. If the new request was an add request, the “yes” branch is followed from step 465 to step 467. In step 467, the update process 450 sets the failed add counter to zero in preparation for adding the entry. In an alternative embodiment without a failed add counter, the update process 450 skips this step.

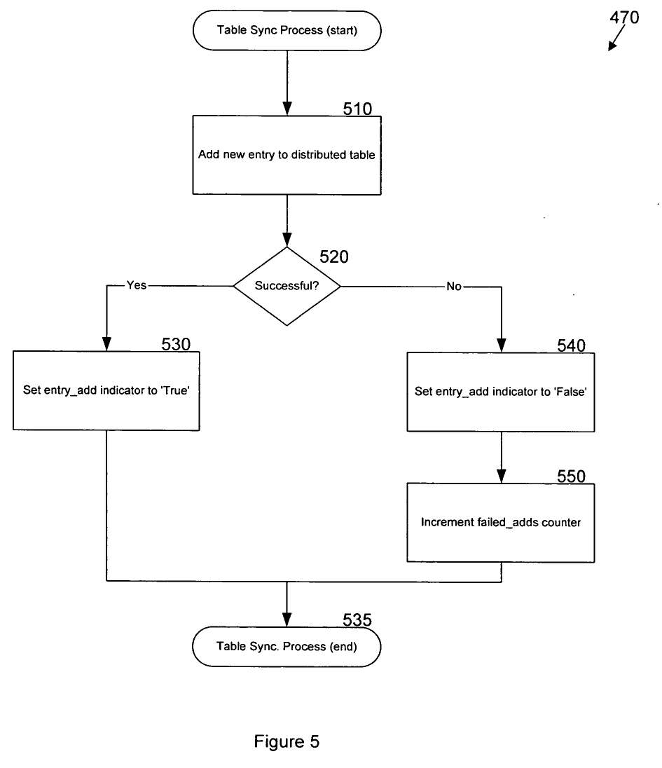

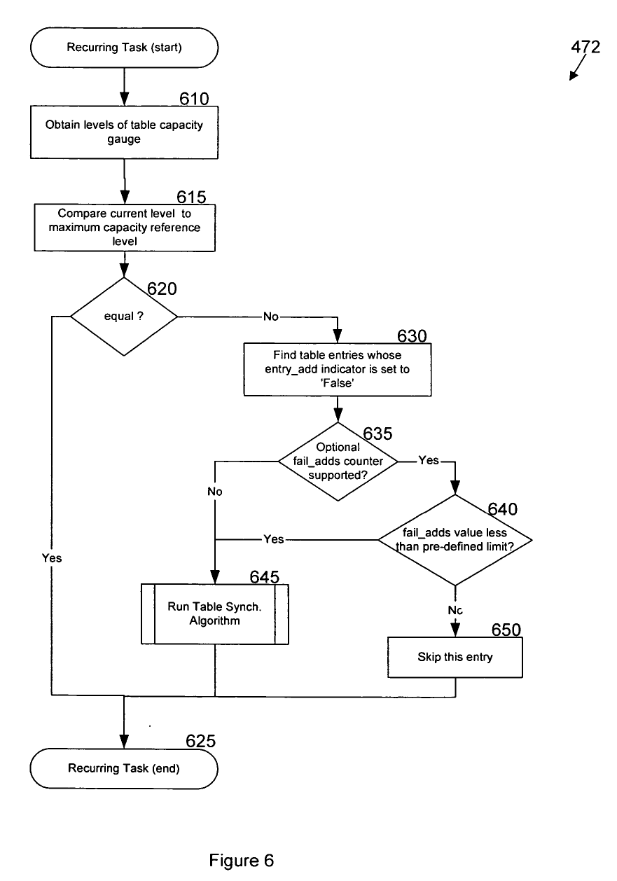

Step 467 is followed by step 470. In step 470, the update process 450 runs the table synchronization subroutine, which embodies the Table Synchronization Algorithm 223. This subroutine is described in greater detail with respect to FIG. 5. Step 470 is followed by step 472 where the update process 450 initiates the recurring task subroutine 225, which embodies the recurring task algorithm 225. The recurring task subroutine 225 is described in greater detail with respect to FIG. 6. Once started, this subroutine runs independently of the update process 450. The step 472 is followed by the end step 473.

If an add request was not received in step 465, the “no” branch is followed from step 465 to step 474. In step 474, the update process 450 determines if it received a modify request. To accomplish this step, the update process 450 may use a separately running protocol. That is, this process determines if the information previously stored in the entry should be changed. If a modify request was received, the “yes” branch is followed from step 474 to step 476. In step 476, the update process 450 determines if the last attempt to add data to that entry failed. The manner that the update process 450 determines this step is described with reference to FIG. 5. If the last add attempt did fail, the entry-add indicator is set to FALSE. Therefore, the “yes” branch is followed from step 476 to step 467, which sets the failed add counter equal to zero. This step essentially treats the modify request like an add operation since the last add attempt was unsuccessful. If the last add attempt did not fail, the update process 450 follows the “no” branch from step 476 to step 478. In step 478, the current entry is modified. The step 478 is followed by the end step 473.

If the update process 450 determines that a modify request was not received in step 474, the “no” branch is followed from step 474 to step 480, implying this is a delete request. In step 480, this process determines if the last add request failed. This step is also described in greater detail with reference to FIG. 5. If the last add entry failed, the “yes” branch is followed from step 480 to the end step 473. In other words, it skips the current entry because there is essentially nothing to delete. Note that this step presupposes that the only types of requests that will be received are add, modify, and delete requests such that the only option available at this step is a delete request. However, the invention may be used with any types of requests. If the last entry add did not fail, the “no” branch is followed from step 480 to step 482. In step 482, the update process 450 deletes the current entry. Step 482 is followed by the end step 473.

Turning now to FIG. 5, this figure is a flow chart of the table synchronization subroutine 470, which embodies the Table Synchronization Algorithm 223. After beginning, the subroutine 470 attempts to add a new entry to the distributed table 240 in step 510. In other words, this subroutine is attempting to store the received entry in a storage area within the distributed table 240.

Step 510 is followed by step 520 where the subroutine 470 determines if the entry was successfully added. If the entry was successfully added, the subroutine 470 follows the “yes” branch from step 520 to step 530. In that step, the add indicator described in reference to FIG. 4 is then set to TRUE to indicate that the add operation was successful. Step 530 is then followed by the end step 535.

If the entry was not successfully added, the subroutine 470 follows the “no” branch from step 520 to step 540. In step 540, the subroutine 470 sets the add indicator to FALSE. Step 540 is followed by step 550. In step 550, the subroutine 470 increments the failed add counter. In an alternative embodiment that does not use a failed counter, one skilled in the art will appreciate that step 550 may be omitted. Step 550 is then followed by the end step 535.

FIG. 6 is a flow diagram for the recurring task subroutine 472, which embodies the Recurring Task Algorithm 225. The frequency that this routine runs may be either fixed or irregular. In one embodiment, the present invention uses a message based mechanism that may invoke this routine on demand. In an alternative embodiment, the invention may invoke the routine using a fixed timer system with any one of a host of frequencies, such as 5, 20, 60 or some other suitable number. In step 610, the subroutine 472 obtains the current capacity level 320 and the maximum capacity level 310 from the gauge 250. After completing step 610, the subroutine 472 compares the current capacity level 320 to the maximum capacity level 310 in step 620. If they are equal, the end step 625 follows step 620 because there is no advantage in adding the entry since it will produce a failure.

Otherwise, the “no” branch is followed from step 620 to step 630. In step 630, the subroutine 472 attempts to find table entries whose add indicator is set to FALSE. That is, subroutine 472 searches for all individual tables, or hash groups, entries that were not previously successful in storing.

The decision step 635 follows step 630. In step 635, the subroutine 472 determines if the device 200 includes a failed add counter previously described in reference to FIG. 4. When there is a failed add counter, the “yes” branch is followed from step 635 to step 640. In step 640, the subroutine 472 determines if the failed value is less than the predefined fail limit. This limit may be predefined such that, after a specified number of attempts, the system no longer tries to add the value. For example, the fail limit may be four, seven, or some other number.

If the failed add value is less than this limit, the subroutine 472 follows the “yes” branch from step 640 to step 645. In step 645, the subroutine 472 completes the table synchronization subroutine 470 described with reference to FIG. 5. That is, the subroutine 472 attempts to add the previously failed entry to the appropriate table once again. Otherwise, the subroutine 472 follows the “no” branch from step 640 to step 650. In step 650, the subroutine 472 skips the entry. In other words, the subroutine 472 recognizes that it should not attempt to add this entry given the number of times that it previously failed. After skipping the entry in step 650, the subroutine moves to the end step 625.

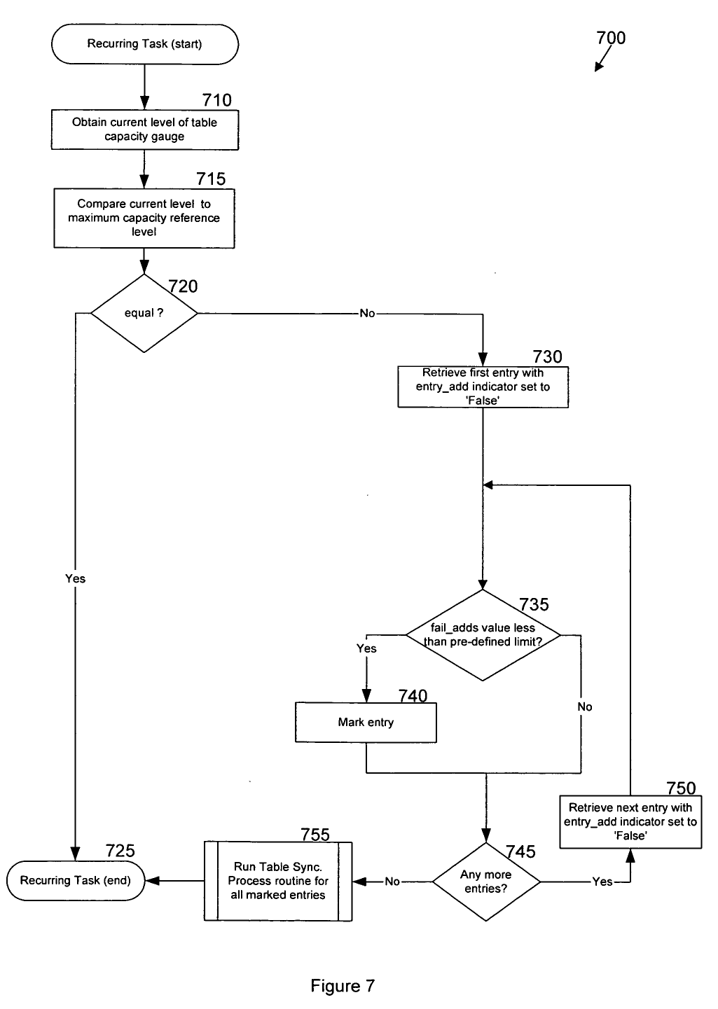

Turning now to FIG. 7, this figure depicts an alternative embodiment using a recurring task subroutine 700. In step 710, the subroutine 700 obtains the current capacity level 320 from the gauge 250. After completing step 710, this subroutine compares the current capacity level 320 to the maximum capacity level 310 in step 715. In step 720, the subroutine 700 determines if these capacity levels are equal. If these levels are equal, the end step 725 follows step 720 because there is no advantage in adding the entry since it will produce a failure.

If they are not equal, the subroutine 700 follows the “no” branch from step 720 to step 730. In step 730, the subroutine 700 retrieves the first entry whose add indicator is set to FALSE. Step 735 follows step 730 in which the routine 700 determines if the current failed add value is less than the predefined limit. If the value is less, the subroutine follows the “yes” branch from step 735 to step 740. In step 740, the subroutine 700 marks the entry. Step 740 is followed by step 745. If the failed add value is not less than the predefined limit, the “no” branch is followed from step 735 to step 745.

In step 745, the subroutine 700 determines if there are any more previously unsuccessful entries. If there are additional entries, the “yes” branch is followed from step 745 to step 750. In step 750, the subroutine 700 retrieves the next entry with an add indicator set to FALSE. Step 750 is followed by step 735.

If there are not any more entries, the “no” branch is followed from step 745 to step 755. In step 755, the subroutine runs the table synchronization subroutine 470 for all marked entries. The end step 725 follows step 755.

One skilled in the art will appreciate that the subroutine 700 is functionally identical to the subroutine 472 described with reference to FIG. 6. However, the subroutine 700 allows identification of all entries with failed add indicators before the table synchronization process is run. Therefore this subroutine self corrects all updating errors simultaneously instead of correcting them one at a time, like subroutine 472. Consequently, FIG. 7 represents one of many similar flow diagrams that may accomplish the same function that is within the scope of this invention. Alternatively, dynamic start and stop pointers may be used to manage the list of failed entries, which prevents the algorithm from always starting with the first failed entry.

A system for self-correcting updates in a distributed data table according to the present invention creates a host of advantages. For example, failures due to temporary conditions in the distributed table are recoverable. Moreover, the recurring task algorithm avoids overburdening the processor 210 because of unbounded entry-add, retry attempts. In the implementation described with reference to FIG. 7, the subroutine 700 improves processing efficiency by batching add-entry, retry attempts. In other words, the retries are completed in batches. Finally, the gauge 250 prevents needless entry-add, retry attempts by the processor 210 when the table is completely full by monitoring the current table capacity level.

The particular embodiments disclosed above are illustrative only, as the invention may be modified and practiced in different, but equivalent, manners apparent to those skilled in the art having the benefit of the teachings herein. Furthermore, no limitations are intended to the details of construction or design herein shown, other than as described in the claims below. It is therefore evident that the particular embodiments disclosed above may be modified and all such variations are considered within the scope and spirit of the invention. Accordingly, the protection sought herein is as set forth in the claims below.

1. A method for self-correcting updating errors to a distributed data table, comprising:
adding an entry to the distributed data table;
setting a first indicator to reflect whether the step of adding the entry was successful;
periodically comparing a current table capacity level with a maximum table capacity level; and
periodically attempting to add the entry so long as the first indicator reflects a previously unsuccessful add and the current table capacity level is less than the maximum table capacity level.

2. The method of claim 1, further comprising setting a counter to reflect the number of unsuccessful attempts to add the entry.

3. The method of claim 2, further comprising ending the periodic attempts to add when the counter reaches a predefined limit.

4. The method of claim 1, further comprising:
receiving an update request corresponding to a modify request for a second entry;
determining whether a previous add to the second entry was successful; and
after periodically adding the first entry, periodically attempting to add the second entry if the previous add was unsuccessful and the current table capacity level is less than the maximum table capacity level.

5. The method of claim 1 further comprising:
adding second and third entries to the distributed data table;
setting second and third indicators to reflect whether adding the second and third entries was successful;
identifying all entries with indicators that reflect a previously unsuccessful add; and
periodically attempting to add the identified entries so long as the current table capacity level is less than the maximum table capacity level.

6. A method for self-correcting updating errors to a distributed table, comprising:
processing a first update request;
attempting to change at least one entry in the distributed data table in response to processing the update request;
setting a first indicator to reflect whether the entry was successfully changed;
periodically comparing a maximum table capacity level with a current table capacity level;
periodically setting a second indicator to reflect the current table capacity level; and
periodically attempting to change the entry so long as the first indicator reflects a previously unsuccessful change and the second indicator reflects less than the maximum table capacity level.

7. The method of claim 6 further comprising setting a first counter to reflect a number of unsuccessful attempts to change the entry and ending the periodic attempts to change when the first counter reaches a predefined limit.

8. The method of claim 6 wherein the step of comparing a maximum table capacity level comprises:
determining the current table capacity level each time an entry in the table is successfully added to the table; and
comparing the current table capacity level to the maximum table capacity level.

9. The method of claim 6 wherein processing the first update request comprises determining whether the update request was an add request, modify request or delete request.

10. The method of claim 9 further comprising when the update request was the modify request:
determining if a previous attempt to add the entry was successful; and
modifying the entry when the previous attempt to change the entry was successful.

11. The method of claim 9 further comprising when the update request was the modify request determining if the previous attempt to add the entry was successful before periodically attempting to change the entry when the previous attempt to change the entry was not successful.

12. The method of claim 8 further comprising when the update request was the delete request:
determining if the previous attempt to add the entry was successful; and
deleting the entry when the previous attempt to change the entry was successful.

13. A computing device for self-correcting updating errors comprising:
a main data table having a plurality of entries;
a distributed data table having a plurality of entries, wherein the entries in the distributed data table are representatives of entries in the main data table;
a processor coupled to the distributed data table and the main data table, wherein the processor periodically produces update requests so the entries in the distributed data table reflect changes in the main data table; and
an apparatus for storing algorithms that is coupled to the processor, wherein the algorithms self correct updating errors for the distributed data table.

14. The computing device of claim 13 further comprising a gauge coupled to the distributed data table, wherein the gauge periodically determines a current capacity level for the distributed data table.

15. The computing device of claim 13 wherein the algorithms are for:
processing a first update request;
attempting to change at least one entry in the table in response to processing the update request;
setting a first indicator to reflect whether the entry was successfully changed;
periodically comparing a maximum table capacity level with a current table capacity level;
periodically setting a second indicator to reflect the current table capacity level; and
periodically attempting to change the entry so long as the first indicator reflects a previously unsuccessful change and the second indicator reflects less than the maximum table capacity level.

16. The computing device of claim 15 wherein the algorithms comprise a synchronization algorithm for adding new entries and recording unsuccessful attempts to the distributed data table during the update process and a recurring task algorithm for correcting updating errors.

17. The computing device of claim 13 wherein the data table is a main data table.

18. The computing device of claim 13 wherein the first indicator displays a value of TRUE when the entry was successfully added and a value of FALSE when the entry was not successfully added.

19. The computing device of claim 13 wherein the apparatus is a memory storage device.

20. A means for self-correcting updating errors to a distributed table, comprising:
a means for processing a first update request;
a means for attempting to change at least one entry in the distributed data table in response to processing the update request;
a means for setting a first indicator to reflect whether the entry was successfully added; a means for periodically comparing a maximum table capacity level with a current table capacity level;
a means for periodically setting a second indicator to reflect the current table capacity level; and
a means for periodically attempting to change the entry so long as the first indicator reflects a previously unsuccessful change and the second indicator reflects less than the maximum table capacity level.
